(19) United States
(12) Patent Application Publication
(10) Pub. No.: US 2016/0125295 A1
(43) Pub. Date: May 5, 2016

(54) USER-INTERACTION TOY AND INTERACTION METHOD OF THE TOY

(71) Applicant: Jae Min YUN, Ansan-si (KR)

(72) Inventor: Jae Min YUN, Ansan-si (KR)

(73) Assignee: YALLY INC., Ansan-si (KR)

(21) Appl. No.: 14/582,374

(22) Filed: Dec. 24, 2014

(30) Foreign Application Priority Data
Oct. 31, 2014 (KR) 10-2014-0150358

(51) Int. Cl. G06N 5/04; G06N 3/00

(52) U.S. Cl. CPC G06N 5/04; G06N 3/008

(57) ABSTRACT

The present invention relates to a user-interaction toy and an interaction method of the toy, and more particularly, to a user-interaction toy and an interaction method of the toy that recognize an intention of a user's action and select a reaction thereto, and output the intention and the reaction to a user. According to embodiments of the present invention, there is a provided a user-interaction toy that can more accurately determine a user's intention by sensing means including two or more sensors, and as a result, an appropriate response is made to a user to commune with the user through voice, sound, an action, and video, thereby enjoying the toy more vividly, a toy which interacts with the user.

### CROSS-REFERENCE TO RELATED APPLICATION

This application claims priority from Korean Patent Application No. 10-2014-0150358 filed on Oct. 31, 2014 in the Korean Intellectual Property Office, the contents of which in its entirety are herein incorporated by reference.

### TECHNICAL FIELD

The present invention relates to a user-interaction toy and an interaction method of the toy, and more particularly, to a user-interaction toy and an interaction method of the toy that recognize an intention of a user's action and select a reaction thereto, and output the intention and the reaction to a user.

### BACKGROUND

In the related art, an interactive toy has a level to recognize user's voice and reply through several voice answers in response to the recognized voice. In order to further solve the problem of the interactive toy, a toy that senses an action such as a user's touch, or the like to response according to the sensed action may be started, but even in this case, one action is recognized by one type of sensing means, and as a result, actions that are similar but expressing a user's another feeling or intention cannot be more accurately recognized, and as a result, an action of more minute communion with a user cannot be provided.

### SUMMARY

The present invention has been made in an effort to provide a user-interaction toy that can more accurately determine a user's intention by sensing means including two or more sensors, and as a result, an appropriate response is made to a user to commune with the user through voice, sound, an action, and video, thereby enjoying the toy more realistically, which interacts with the user.

An embodiment of the present invention provides a method for recognizing, by a user's interaction toy (hereinafter, referred to as ‘user's interaction toy’), a user's intention and expressing a reaction thereto, including: (a) determining a meaning (hereinafter, referred to as ‘user's intention’) which a user intends to convey the user-interaction toy based on information acquired by two or more different types of sensors sensing a stimulus (hereinafter, referred to as ‘input stimulus) caused by the user; and (b) selecting a reaction to be output to the user and outputting the selected reaction to the user based on the determined user's intention.

In step (a), information acquired by the input of each sensor for the input stimulus may be at least one of visual information, auditory information, tactile information, olfactory information, taste information, motion information, and pose information.

Step (a) may include (a11) acquiring an input value for a specific stimulus of the user sensed by each of two or more different types of sensors; (a12) determining contents of information (hereinafter, referred to as ‘input information’) indicating the input stimulus sensed by the corresponding sensor by analyzing the input value sensed by each sensor; and (a13) determining the user's intention for the input information by combining the contents of the input information determined in step (a12).

The method may further include, between steps (a) and (b), (b01) generating, when the user's intention is not confirmed in step (a), at least one output of the voice information, the sound information, the action information, and the video information for the user for the confirmation; and (b02) determining the user's intention based on the user's reaction to the output in step (b01).

In step (b), when the reaction to be output to the user is selected, based on the determined user's intention, at least one of the voice information, the sound information, the action information, and the video information may be output.

In the case whether the user's intention is confirmed or not in step (a), when the reaction to be output to the user is selected and output to the user, contents of the output may be determined through a scenario stored in a database.

According to another embodiment of the present invention, it provides a user's interaction toy (hereinafter, referred to as ‘user's interaction toy’) recognizing a user's intention and expressing a reaction thereto, including: a sensor input unit sensing a stimulus (hereinafter, referred to as ‘input stimulus’) caused by the user to acquire an input value for the input stimulus; an output unit generating an output corresponding to a user's input; a user's intention determination unit determining a meaning (hereinafter, referred to as ‘user's intention) which the user intends to transfer to the user-interaction toy based on information acquired by inputs of two or more different types of sensors of the sensor input unit sensing the input stimulus; an output determination unit selecting a reaction to be output to the user based on the user's intention determined by the user's intention determination unit; and a determination reference database storing reference data for determining the user's intention.

Information acquired by the input of each sensor for the input stimulus may be at least one of visual information, auditory information, tactile information, olfactory information, taste information, motion information, and pose information.

The toy may further include an input information content determination unit analyzing an input value of a specific input stimulus acquired by each of two or more different types of sensors of the sensor input unit to determine contents of information (hereinafter, referred to as ‘input information’) indicating the input stimulus sensed by the corresponding sensor, wherein the user's intention determination unit combines contents of the input information determined by the input information content determination unit by using the input value sensed in each sensor to determine the user's intention for the input stimulus.

The user's intention determination unit may further include an output information database further including a function to control the output determination unit to at least one output of the voice information, the sound information, the action information, and the video information for confirmation when the user's intention is not confirmed from the determination based on the information acquired by two or more different types of sensor inputs of the sensor input unit and determine the user's intention based on a user's reaction to the corresponding output, and storing at least one of the voice information, the sound information, the action information, and the video information.

The toy may further include, when the output determination unit selects a reaction to be output to the user and outputs the selected reaction to the user based on the determined user's intention, an output information database outputting at least one of the voice information, the sound information, the action information, and the video information and storing at least one of the voice information, the sound information, the action information, and the video information.

The toy may further include, in the case where the user's intention is confirmed or not confirmed by the user's intention determination unit, when the reaction to be output to the user is selected and output to the user, a scenario database storing a scenario to determine contents of the output.

According to embodiments of the present invention, there is provided a user-interaction toy that can more accurately determine a user's intention by sensing means including two or more sensors, and as a result, an appropriate response is made to a user to commune with the user through voice, sound, an action, and video, thereby enjoying the toy more realistically, which interacts with the user.

The technical objects of the present invention are not limited to the aforementioned technical objects, and other technical objects, which are not mentioned above, will be apparent to those skilled in the art from the following description.

### BRIEF DESCRIPTION OF THE DRAWINGS

The above and other features and advantages of the present invention will become more apparent by describing in detail embodiments thereof with reference to the attached drawings in which:

FIG. 1 is a flowchart for a user-interaction toy to perform a reaction expression to a user input according to the present invention;

FIG. 2 is a diagram illustrating an embodiment of a user's intention determination table based on a sensor when a user's specific action is sensed by various sensors;

FIG. 3 is a diagram illustrating a determination table in which a pattern of an action or recognized voice contents which may be input from a user are arranged similarly in both a row and a column and a user's intention is determined by the matching as another embodiment of a method for determining the user's intention;

FIG. 4 is a diagram illustrating an embodiment in which contents of the user's intention are subdivided in detail;

FIG. 5 is a diagram illustrating an embodiment of a user's intention determination table when the user's intention is divided as illustrated in FIG. 4;

FIG. 6 is a diagram illustrating a determination table for secondarily determining the user's intention from a reaction of a user to voice output with respect to the user for confirmation when the user's intention is not determined by the user's action as yet another embodiment of the method for determining the user's intention;

FIG. 7 is a diagram illustrating a configuration of the user's interaction toy according to the present invention;

FIG. 8 is a diagram illustrating an embodiment of contents of voice information, sound information, action information, and video information which are determined to be output from an output determination unit;

FIG. 9 is a diagram illustrating patterns of a question and an answer used in both the case where the user's intention is confirmed or the case where the user's intention is not confirmed; and

FIG. 10 is a diagram illustrating a flow of a scenario constituted by the question and the answer as an embodiment.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

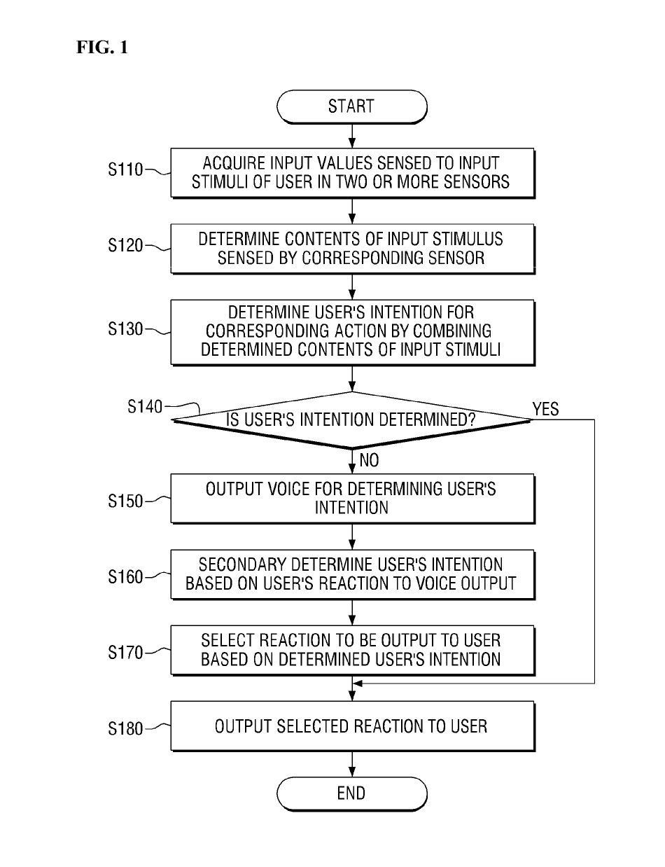

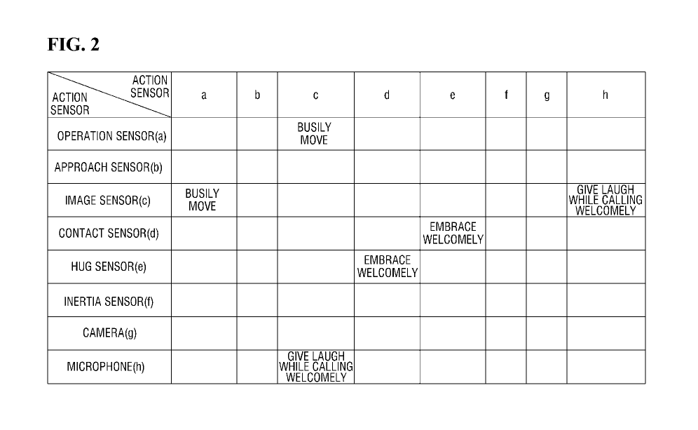

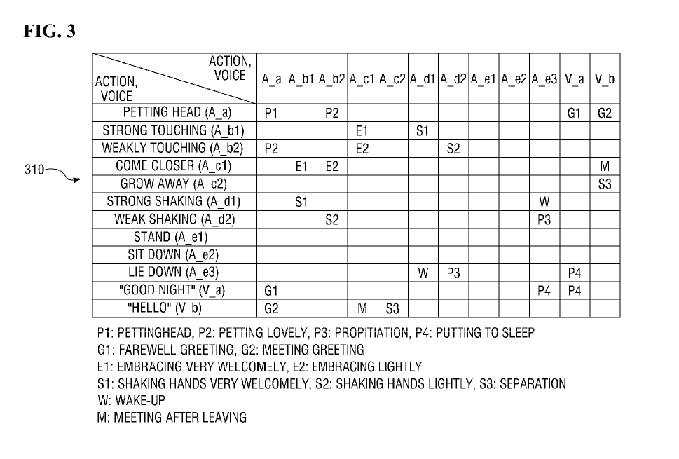

FIG. 1 is a flowchart for a user-interaction toy to perform a reaction expression to a user input according to the present invention. FIG. 2 is a diagram illustrating an embodiment of a user's intention determination table based on a sensor when a user's specific action is sensed by various sensors. FIG. 3 is a diagram illustrating a determination table in which a pattern of an action or recognized contents which may be input from a user are arranged similarly in both a row and a column and a user's intention is determined by the matching as another embodiment of a method for determining the user's intention.

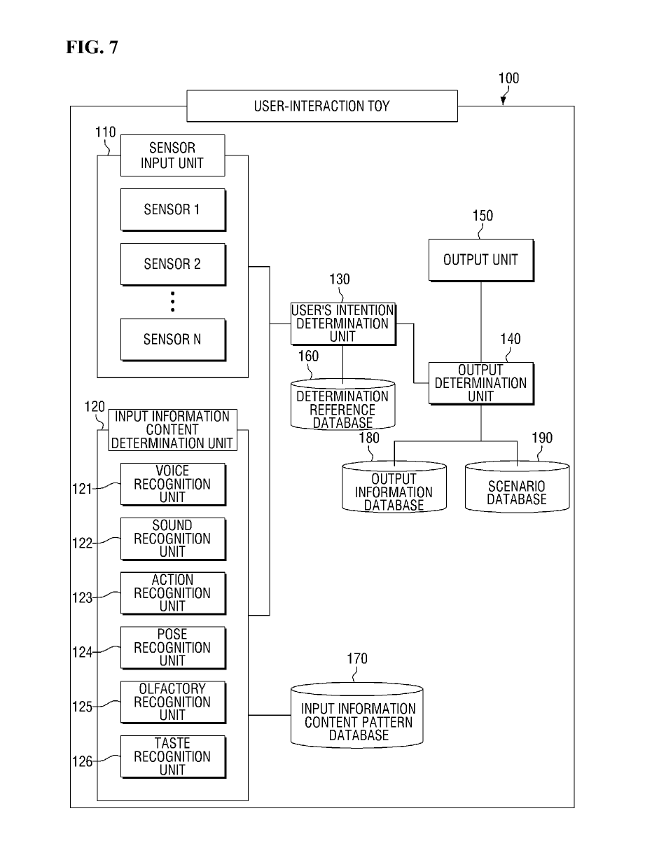

Hereinafter, according to the flowchart of FIG. 1, the method of the present invention will be described with reference to the tables according to the embodiment of FIGS. 2 and 3. The determination table of FIG. 2 or 3 may be stored in a determination reference database 160 (see FIG. 7) of a user's interaction toy 100 (see FIG. 7) of the present invention.

First, a user inputs a specific action, pose, voice, sound, or the like in the toy 100 and acquires input values sensed with respect to the action, pose, voice, sound, and the like from two or more sensors of the toy 100 (S110). Herein, the ‘action’ means various operations including a gesture, petting the toy 100 or shaking with the toy 100, head shaking, blinking, a pupil's position, a facial expression, a touch, proximity, a motion (operation) such as movement, and the like. The pose means a static pose of the user, and the like. The voice means sound which may be recognized as ‘speech’ among human voices and the ‘sound’ means sound which is difficult to express as the ‘speech’, such as laughing sound, crying sound, cough sound, simple shouting, and the like. Further, more widely, (the stimuli may include smell, taste, and the like caused by the user and the stimulus is also one of types the user may input in the toy 100.

That is, ‘inputting’ user's action, pose, voice, and sound, more widely, the smell, the taste, and the like caused by the user means allowing various sensors provided in the toy to sense the action, the pose, the voice, the sound, the smell, the taste, and the like caused by the user.

When the description is summarized, information which may be acquired by the user's input into each sensor of the toy may include various stimuli including visual information, auditory (sound) information, tactile information, olfactory information, taste information, motion information, pose information, and the like.

As described through step S130 given below, the action, the pose, the voice, the sound, the smell, the taste, and the like caused by the user are input into the sensor of the toy 100 and thereafter, an intention of the user is determined from the input information. Thereafter, the input that are input into the toy through the sensor to operate as elements for allowing the toy to determine the intention of the user, that is, various stimuli including the action, the pose, the voice, the sound, the smell, the taste, and the like caused by the user may be collectively called ‘input stimuli’.

For example, all sounds including the voice and the sound of the user among the input stimuli may be input into a ‘sound sensor’ or a microphone of a sensor input unit 110 of the toy and a voice recognition unit 121 of an input information content determination unit 120 may recognize the ‘voice’ as a dialogue of the user therefrom. Further, a sound recognition unit 122 recognizes the aforementioned content of the ‘sound’ as the input sound. Further, an action recognition unit 123 recognizes contents of various actions of the user and a pose recognition unit 124 recognizes contents of various poses of the user.

As described above, FIG. 2 is a diagram illustrating an embodiment of a user's intention determination table based on the sensor. That is, the present invention is a technical spirit that a specific input stimulus of the user is sensed by various sensors (input device) to analyze input data, thereby more accurately identify the intention of the user including a purpose, a situation, and an emotion of the user than the existing invention. Sensors sensing various input stimuli of the user are arranged in row 1 and column 1 of FIG. 2 and the user's intention sensed and determined by the corresponding sensors are shown in a compartment in which each row and each column match each other.

In FIG. 3, not the sensor itself but contents of an input stimulus sensed and determined by each sensor are disclosed in row 1 and column 1 with respect to the specific input stimulus of the user. That is, an input value sensed by each sensor is analyzed and contents of information (hereinafter, referred to as ‘input information’) indicated by the input stimulus sensed by the corresponding sensor are determined (S120) and thereafter, contents of input information determined with respect to the action are arranged in column 1 and row 1. Thereafter, the determined contents of the input information are combined to determine the user's intention by the input information (S130). The user's intention determined as above is illustrated in the compartment in which each row and each column of FIG. 3 match each other.

A determination table 310 of FIG. 3 is a determination table that allows the user's intention to be determined based on inputs of two or more different types of sensor inputs for the input stimulus from the user. Such a method is configured to be performed by one table. Besides, the determination table of FIG. 3 includes even a case in which the user's intention may be determined based on an input of one sensor for the corresponding input stimulus. Further, a sound element among contents of ‘voice’ is not written in the row and the column of the determination table 310 of FIG. 3, but such an element may also be included in contents of the action of row 1 and column 1 for determining the user's intention, of course.

In the embodiment of the determination table 310 of FIG. 3, ‘A_’ represents an action or a pose sensed by an action sensor or a pose sensor and ‘V_’ represents recognized voice contents of the user. However, in the determination table 310, the contents of the actions arranged in the row or the column mean not the sensed value of the sensor, but he contents of the input stimulus which an input information content determination unit 120 (see FIG. 7) recognizes from the sensed value of the sensor.

In the determination table 310, for example, ‘strong touching A_b1’ and ‘soft touching A_b2’ mean contents of actions recognized by the action recognition unit 123 (see FIG. 7 and a description part thereof), from touch action values sensed as respective different values by a touch sensor of the sensor input unit 110 (see FIG. 7). As described above, the action recognition unit 123 recognizes a pattern of the action from a value sensed with respect to the action in the action sensor by using an input information content pattern database 170. That is, all of ‘head petting A_a’, strong touching A_b1′, ‘soft touching A_b2’, and the like, which are written on a left column in the determination table 310 mean the contents of the actions recognized by the action recognition unit 123.

Similarly, ‘stand-up A_e1’, ‘sit-down A_e2’, and ‘lie-down A_e3’ also mean the contents of the actions recognized by the action recognition unit 123 or the pose recognition unit 124 from values sensed by inclination sensors of the sensor input unit 110, respectively and respective pairs of “A_c1 and A_c2” and “A_d1 and A_d2” also mean the contents of the actions recognized by the action recognition unit 123 from actions values sensed as different values by one sensor.

Referring to the determination table 310, when it is recognized that the toy 100 lies down by the action value sensed by the inclination sensor (A_e3) and the toy 100 is weakly shaken by an action value sensed in an acceleration sensor (A_d2), it is primarily determined that the user does an action having an intention of ‘putting to sleep’ with respect to the toy at present by two recognized input stimuli contents (or patterns).

For example, in spite of the same action of embracing the toy 100, recognitions of the actions are different depending on a difference between the input values sensed by the touch sensors (A_b1 and A_b2) and the intention included in the action of the user is also discriminated into ‘very welcomely embracing’ or ‘lightly embracing’ to be primarily determined therefrom.

Referring to the determination table 310 of FIG. 3, an example is also illustrated, in which the user's intention is determined based on inputs of one or more sensors for the user's action and the contents determined by recognizing the input voice. That is, when it is recognized that the user approaches by the action value sensed by the acceleration sensor (A_c1), if the voice of the user is recognized as “hello”, as the user's intention may be determined that the user approaches toward the toy 100 from another place, that is, ‘meeting after leaving’ may be determined as the user's intention in the determination table 310. Further, when it is recognized that the user is far off by the action value sensed by the acceleration sensor (A_c2), if the voice of the user is recognized as “hello”, as the user's intention may be determined that the user stays along with the toy 100 and thereafter, leaves from the toy 100, that is, ‘separation’ may be determined as the user's intention in the determination table 310.

In the determination table 310 of FIG. 3, for example, when both the actions of the row and the column are ‘A_a’, the user's intention is determined from the action recognized by one sensor input value and when static electricity of a head part is sensed by an electrostatic sensor, as the user's intention may be directly determined that the user performs ‘head petting’. Of course, whether to determine the intention by using only an electrostatic sensor value or both the electrostatic sensor and touch sensor values is a problem considering how elaborately to determine the user's intention.

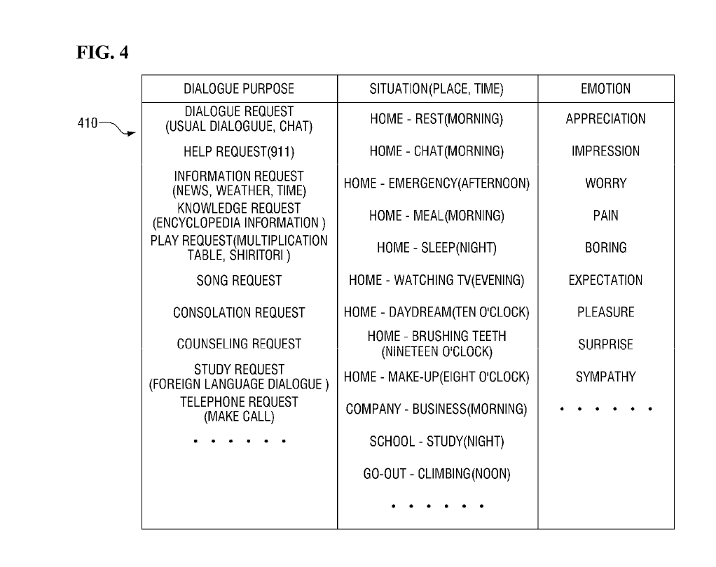

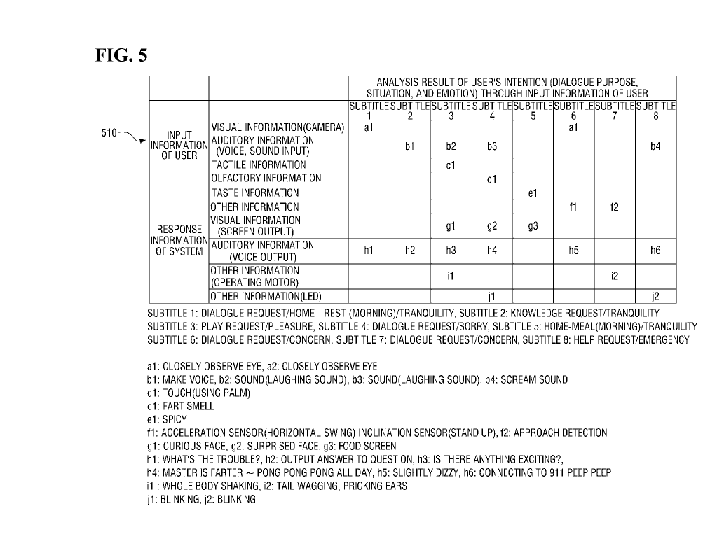

FIG. 4 is a diagram illustrating an embodiment 410 in which contents of the user's intention are subdivided in detail. FIG. 5 is a diagram illustrating an embodiment of a user's intention determination table 510 when the user's intention is divided as illustrated in FIG. 4.

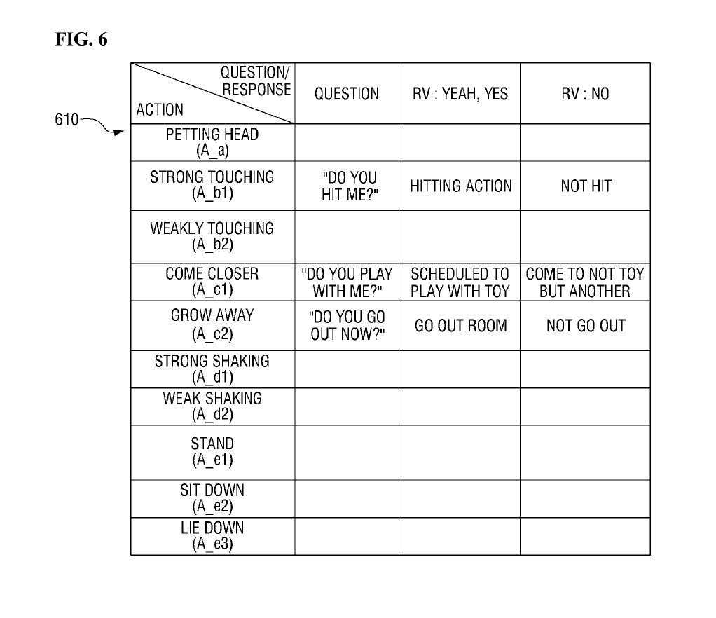

In FIG. 4, the user's intention is divided into the ‘dialogue purpose’, the ‘situation’, and the ‘emotion’ and row 2 of FIG. 5 shows the user's intention which is divided into three elements as such. As shown on row 2 of FIG. 5, all of three elements of the user dialogue purpose, the situation, and the emotion may be analyzed and only one or two elements may be analyzed. In this case, even one element may not be analyzed, but although the element is analyzed, determining the user's intention may also be insufficient. The embodiment in this case will be described below with reference to FIG. 6.

The user may first present the intention to the system (provide the visual, auditor, tactile, and other sensor information) and the system may ask a question in order to notify the intention to the user (provide the visual, auditor, tactile, and other sensor information). In the case of the latter, the user's intention is not confirmed by the determination by the sensor input.

In description according to an example of the table 410, when the user's action is analyzed through one or two or more sensor inputs, the ‘dialogue purpose’ of the user may be determined as a ‘dialogue request’, the current ‘situation’ may be determined as a situation (home—rest (morning)) in which the user takes a rest in the morning, and the current emotion may be determined as pleasure.

For example, when the user says “I have a stomachache” (auditory sensor) while knitting his/her brows, the toy 100 may determine that the user's intention is “help request” and the current emotion is “pain”.

A dialogue between the user and the toy 100 may be variously configured according to a scenario. A scenario DB is constructed in advance, and as a result, another scenario may be applied according to the current user's intention (dialogue purpose), situation, and emotion.

An embodiment of secondarily determining the user's intention from a reaction of the user to a voice output with respect to the user will be further described below with reference to FIGS. 6 and 4.

Meanwhile, the user's intention may not be determined even through the aforementioned step. FIG. 6 is a diagram illustrating a determination table for secondarily determining the user's intention from a reaction of a user to voice output with respect to the user for confirmation when the user's intention is not accurately determined by the user's input stimulus by the aforementioned step as yet another embodiment of the method for determining the user's intention.

For example, in the table 310 of FIG. 3, it is recognized that the user strongly touches the toy 100 by the input value sensed by the touch sensor and in this case, if there is no content sensed by another sensor, it is difficult to determine the user's intention from the table 310 of FIG. 3. In this case, the toy 100 may output a voice asking “do you hit me?” to the user for confirming the intention (S150). Thereafter, if a response voice (RV) from the user is recognized as ‘yeah’ or ‘yes’, the user's intention that the user hits the toy is determined and if the response voice (RV) from the user is recognized as ‘no’, and the like, the user's intention that the user does not hit the toy may be secondarily determined (S160).

That is, when the user's intention is not confirmed, the voice information is output to the user as described above or at least one of the sound information, the action information, and the video information is output in addition to the voice information for the confirmation and the user's intention is determined based on the user's reaction to the output.

Which voice is output and how the output voice matches the resulting user's reaction, and as a result, what intention the reaction is determined as may be made by very various methods within the scope of the technical spirit of the present invention, of course.

When the embodiment of secondarily determining the user's intention from the user's reaction to the voice to the user is described with reference to FIG. 4 for the confirmation, all of three elements of the user's dialogue purpose, the situation, and the emotion may be analyzed or only one or two elements may be analyzed. In this case, even one element may not be analyzed, but although the element is analyzed, when determining the user's intention is insufficient, the user's intention may be determined through reasking.

As another example, when the user says “I have a stomachache” (auditory sensor), the toy 100 may ask “who is painful?” again and when the user answers “father?”, the system says “Call 911 if it is really painful. Do you want to connect 911?” and when the user accepts it (for example, “yes”), a telephone call may be directly connected.

When the user says “I want to have a bread”, while the toy 100 says “What bread do you want to have?”, a bread picture may be displayed on a screen (provide the visual information) and the user selects one thereof (touch the bread picture with a finger select it by speaking No. 1 and No. 2 through the voice, or directly speak a bread name) to order the selected one on-line.

If the user's intention is determined in steps (S140 and S160) in which the user's intention may be determined through steps up to now, a reaction which the toy 100 will output to the user with respect to the determined user's intention is selected based on the determined user′ intention (S170). The output may be the voice or an operation of the toy. The selected reaction is output (S180) to perform a reaction expression of the toy 100 to the user's action or voice.

FIG. 7 is a diagram illustrating a configuration of the user's interaction toy 100 according to the present invention. Since a reaction process performed by the toy 100 has been described in detail through the flowchart and the embodiment of the table for determining the user's intention up to now, only the functions of the respective configuration modules of the user's interaction toy 100 that performs such a process will be described below in brief.

The sensor input unit 110 senses the user's input stimulus to acquire the input value for the input stimulus. The sensed input stimulus includes various ‘stimuli’ including the action, the pose, the voice, the sound, the smell, the taste, and the like as described above.

The input information content determination unit 120 recognizes a pattern of the action from an input value for a sensed specific input stimulus of the user, which is acquired in each of two or more different types of sensors of the sensor input unit 110 to determine contents of information acquired by the input stimulus sensed by the corresponding sensor, and as a result, the user's intention determination unit 130 combines the contents of the actions determined by the input information content determination unit 120 by using the input value sensed by each sensor to determine the user's intention for the input stimulus.

The input information content determination unit 120 recognizes the voice, the sound, the action, the pose, the smell, the taste, and the like by using the input information content pattern database 170 from the value sensed with respect to the input stimulus sensed in the sensor input unit 110 to determine the contents of the voice, the sound, the action, the pose, the smell, the taste, and the like.

The voice recognition unit 121 of the input information content determination unit 120 recognizes the ‘voice’ as the user's dialogue therefrom. Further, the sound recognition unit 122 recognizes the contents of the sound when the input sound is the aforementioned ‘sound’. Further, an action recognition unit 123 recognizes contents of various actions of the user and a pose recognition unit 124 recognizes contents of various poses of the user. In addition, the input information content determination unit 120 may further include a olfactory recognition unit 125 that recognizes the smell caused by the user and a taste recognition unit 126 that recognizes the taste caused by the user.

The user's intention determination unit 130 determines a meaning (hereinafter, referred to ‘user's intention’) which the user intends to transfer to the user's interaction toy 100 based on the information acquired by two or more different types of sensor inputs of the sensor input unit 110. That is, the input stimulus is sensed in the sensor input unit 110, the input information content determination unit 120 determines contents regarding the sensed input stimulus, and thereafter, the user's intention determination unit 130 determines the user's intention from the determined contents of the input information.

A determination reference database 160 for determination in this case stores reference data for determining the user's intention. An embodiment of the reference data has been exemplarily described through the determination tables of FIGS. 2 to 5.

The output determination unit 140 selects the reaction to be output to the user based on the user's intention determined by the user's intention determination unit 130. The output determination unit 140 determines the reaction to be output to the user to be output by one or more schemes of the voice information, the sound information, the action information, and the video information. The output determination unit 140 includes an output information database 180 for this (S180).

When the user's intention determination unit 130 may not determine the user's intention even by the input stimulus sensed by the sensor input unit 110 and the determination of the contents regarding the input stimulus sensed as such by the input information content determination unit 120, the output determination unit 140 determines what voice to output for determining the user's intention to the user (see FIG. 1 and S150). In this case, the output is not limited to only the voice, that is, the output may be made by one or more schemes of the sound information, the action information, and the video information in addition to the voice information.

That is, the output determination unit 140 determines the output to the user even when the user's intention is confirmed or not confirmed from the determination by the user's intention determination unit 130 and in this case, the output contents may be determined through a scenario database 190.

An output unit 150 generates the output determined by the output determination unit 140 in response to the user's input and as determined by the output determination unit 140, the output unit 150 generates the output by one or more schemes of the voice information, the sound information, the action information, and the video information.

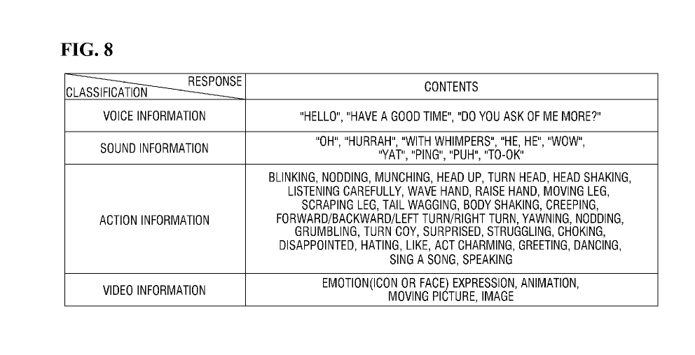

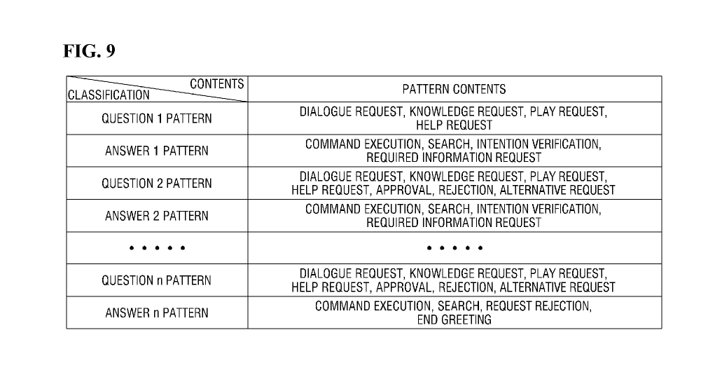

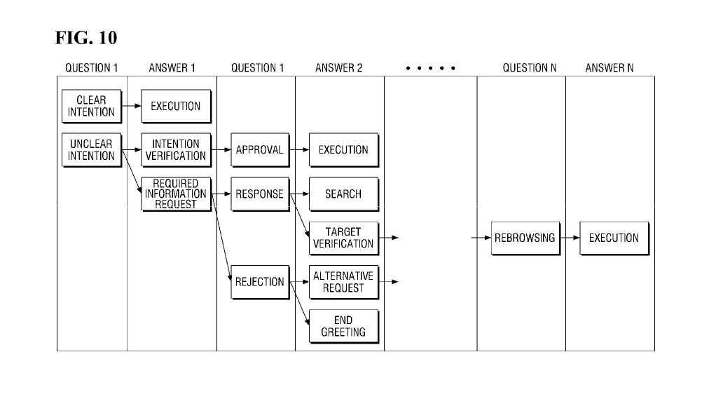

FIG. 8 is a diagram illustrating an embodiment of contents of the output information database 180 storing voice information, sound information, action information, and video information which are determined to be output from an output determination unit 140. FIG. 9 is a diagram illustrating patterns of a question and an answer used in both the case where the user's intention is confirmed or the case where the user's intention is not confirmed. FIG. 10 is a diagram illustrating a flow of a scenario constituted by the question and the answer as an embodiment.

In the case of a dialogue request, a knowledge request, a play request, and the like corresponding to [question 1 pattern], the user's intention is clearly confirmed, in the scenario database 190.

When the user's intention is unclear in [question 1 pattern], an answer corresponding to ‘intention confirmation’ or ‘required information request’ is output to the user in [answer 1 pattern]. For example, when the user outputs the voice “Call me”, since the user's intention is not clear, the toy 100 asks “who do you want to call” again to output the question to the user.

When the user's intention is confirmed in [question 1 pattern], answers which match the user's intention, such as ‘command execution’, ‘search’, and the like are output in [answer 1 pattern]. For example, when the user requests “play dialogue” “play a song of Pororo”, since the user's intention is clear, an action such as finding and playing the song of “Pororo” on a local or outputting a moving picture by searching the song of “Pororo” in YouTube may be taken together with an answer mention “Give you the song of Pororo.”.

That is, the control may be executed according to the scenario database 190 regardless of the confirmation of the user's intention. A scenario may be a kind of rule based intelligent system and when the scenario is over coverage of the scenario, the scenario is calculated based on statistics or a probability to present a subsequent scenario.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method for recognizing, by a user's interaction toy (hereinafter, referred to as ‘user's interaction toy’), a user's intention and expressing a reaction thereto, the method comprising:
(a) determining a meaning (hereinafter, referred to as ‘user's intention’) which a user intends to transfer the user-interaction toy based on information acquired by two or more different types of sensors sensing a stimulus (hereinafter, referred to as ‘input stimulus) caused by the user; and
(b) selecting a reaction to be output to the user and outputting the selected reaction to the user based on the determined user's intention.

2. The method of claim 1, wherein in step (a), information acquired by the input of each sensor for the input stimulus is at least one of visual information, auditory information, tactile information, olfactory information, taste information, motion information, and pose information.

3. The method of claim 1, wherein step (a) includes:
(a11) acquiring an input value for a specific stimulus of the user sensed by each of two or more different types of sensors;
(a12) determining contents of information (hereinafter, referred to as ‘input information’) indicating the input stimulus sensed by the corresponding sensor by analyzing the input value sensed by each sensor; and
(a13) determining the user's intention for the input information by combining the contents of the input information determined in step (a12).

4. The method of claim 1, further comprising:
between steps (a) and (b),
(b01) generating, when the user's intention is not confirmed in step (a), at least one output of the voice information, the sound information, the action information, and the video information for the user for the confirmation; and
(b02) determining the user's intention based on the user's reaction to the output in step (b01).

5. The method of claim 1, wherein in step (b), when the reaction to be output to the user is selected and output to the user based on the determined user's intention, at least one of the voice information, the sound information, the action information, and the video information is output.

6. The method of claim 4, wherein in the case where the user's intention is confirmed or not confirmed in step (a), when the reaction to be output to the user is selected and output to the user, contents of the output are determined through a scenario stored in a database.

7. A user's interaction toy (hereinafter, referred to as ‘user's interaction toy’) recognizing a user's intention and expressing a reaction thereto, the toy comprising:
a sensor input unit sensing a stimulus (hereinafter, referred to as ‘input stimulus’) caused by the user to acquire an input value for the input stimulus;
an output unit generating an output corresponding to a user's input;
a user's intention determination unit determining a meaning (hereinafter, referred to as ‘user's intention) which the user intends to transfer to the user-interaction toy based on information acquired by inputs of two or more different types of sensors of the sensor input unit sensing the input stimulus;
an output determination unit selecting a reaction to be output to the user based on the user's intention determined by the user's intention determination unit; and
a determination reference database storing reference data for determining the user's intention.

8. The toy of claim 7, wherein information acquired by the input of each sensor for the input stimulus is at least one of visual information, auditory information, tactile information, olfactory information, taste information, motion information, and pose information.

9. The toy of claim 7, further comprising:
an input information content determination unit analyzing an input value of a specific input stimulus acquired by each of two or more different types of sensors of the sensor input unit to determine contents of information (hereinafter, referred to as ‘input information’) indicating the input stimulus sensed by the corresponding sensor,
wherein the user's intention determination unit combines contents of the input information determined by the input information content determination unit by using the input value sensed in each sensor to determine the user's intention for the input stimulus.

10. The toy of claim 7, wherein the user's intention determination unit further includes
an output information database further including a function to control the output determination unit to at least one output of the voice information, the sound information, the action information, and the video information for confirmation when the user's intention is not confirmed from the determination based on the information acquired by two or more different types of sensor inputs of the sensor input unit and determine the user's intention based on a user's reaction to the corresponding output, and
storing at least one of the voice information, the sound information, the action information, and the video information.

11. The toy of claim 7, further comprising:
when the output determination unit selects a reaction to be output to the user and outputs the selected reaction to the user based on the determined user's intention,
an output information database outputting at least one of the voice information, the sound information, the action information, and the video information and storing at least one of the voice information, the sound information, the action information, and the video information.

12. The toy of claim 10, further comprising:
in the case where the user's intention is confirmed or not confirmed by the user's intention determination unit, when the reaction to be output to the user is selected and output to the user,
a scenario database storing a scenario to determine contents of the output.
